(19) United States
(12) Patent Application Publication
(10) Pub. No.: US 2007/0212613 A1
(43) Pub. Date: Sep. 13, 2007

(54) Polymer gel electrolyte and polymer secondary battery using the same

(75) Inventors: Junichi Ishida, Sendai-shi (JP); Yasutaka Kouno, Sendai-shi (JP); Koji Utsugi, Sendai-shi (JP); Hitoshi Ishikawa, Sendai-shi (JP); Hiroshi Kobayashi, Sendai-shi (JP); Shinako Kaneko, Sendai-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NEC TOKIN CORPORATION, Sendai-shi (JP)

(21) Appl. No.: 11/715,332

(22) Filed: Mar. 8, 2007

(30) Foreign Application Priority Data
Mar. 9, 2006 (JP) 2006-064049
Dec. 22, 2006 (JP) 2006-346345

(51) Int. Cl. H01M 10/40

(52) U.S. Cl. 429/303; 429/314

(57) ABSTRACT

A polymer gel electrolyte, comprising a polymer gel including an aprotic organic solvent, a carrier salt and a sulfur-containing organic compound having at least one —O—SO₂— in its chemical structure, for instance, a straight-chain sulfonic acid ester or a cyclic sulfonic acid ester, and a lithium polymer secondary battery using the polymer gel electrolyte and having improved rate performance and cycle performance.

### CROSS-REFERENCE TO RELATED APPLICATIONS

This application is based upon and claims the benefit of priority from prior Japanese Application No. 2006-64049, filed on Mar. 9, 2006, and No. 2006-346345, filed on Dec. 22, 2006, the entire contents of which are incorporated herein by reference.

### BACKGROUND

1. Technical Field

The present invention relates to a polymer gel electrolyte comprising an aprotic solvent, a carrier salt and a sulfur-containing organic compound, and a polymer secondary battery using the same.

2. Related Art

Lithium polymer batteries, because of being capable of being slimmed down, having a high flexibility in shape selection, and using no electrolysis solution with no possibility of its leakage at all, have attracted attention as power sources for portable equipment, etc. More recently, with a lot more functions of portable equipment, there have been growing demands for increased energy densities and improvements in battery performance.

All-important technical challenges now in demand are improved safety, improved high-temperature storability, and improved cycle performance. Of these, the cycle performance has been improved by making innovations in the polymer materials used for gel electrolytes, etc. For instance, JP-A-2002-100406 has come up with improvements by use of a mixture comprising a physical crosslinked type polymer and a chemical cross-linked type gel electrolyte, and JP-A-2003-257490 has proposed improving the ability to impregnate of a pregel solution by the modification of a separator's surface.

There have been various proposals made of electrode material and shape, fabrication conditions, electrolysis solutions, too.

A problem with lithium polymer batteries is that they are poorer than general batteries using liquid electrolytes in terms of both rate performance and cycle performance are poorer. For this reason, battery design and fabrication using positive electrodes, negative electrodes, electrolysis solutions, electrolysis solution additives, and separators corresponding to polymer gels are now still under investigation.

An object of the invention is to provide a polymer gel electrolyte that makes improvements in the rate and cycle performances of a polymer battery or can prevent swelling of the polymer battery by reason of repeated charge-and-discharge cycles or the like as well as a polymer secondary battery.

### SUMMARY

The present invention provides a polymer gel electrolyte comprising an aprotic organic solvent, a carrier salt and a sulfur-containing organic compound having at least one —O—SO₂— in its chemical structure.

In the aforesaid polymer gel electrolyte, the sulfur-containing organic compound is a chain sulfonic acid ester.

In the aforesaid polymer gel electrolyte, the sulfur-containing organic compound having a cyclic structure is represented by either one of the following chemical formulae 1 and 2.

In chemical formula 1, X is indicative of an alkylene group that may have a side chain, or an oxygen atom; Y stands for an alkylene group that may have a side chain, or an unsubstituted alkylene group; and Z indicates a methylene group or a single bond.

In chemical formula 2, n is any one of 0, 1, and 2, and R₁-R₆ are each independently selected from a hydrogen atom, an alkyl group having 1 to 12 carbon atoms inclusive, a cycloalkyl group having 3 to 6 carbon atoms inclusive, and an aryl group having 6 to 12 carbon atoms inclusive.

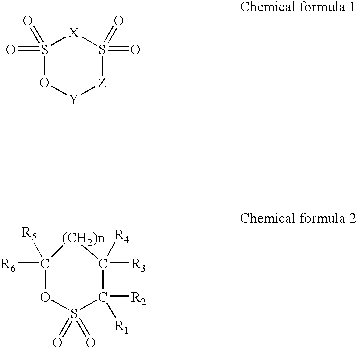

In the aforesaid polymer gel electrolyte, the sulfur-containing organic compound having a cyclic structure is at least one of 1,3-propane sultone or 1,4-butane sultone.

In the aforesaid polymer gel electrolyte, the sulfur-containing organic compound having a cyclic structure is at least one cyclic disulfonic acid ester selected from methylenemethane disulfonate, ethyleneethane disulfonate and propylenemethane disulfonate.

In the aforesaid polymer gel electrolyte, the sulfur-containing organic compound is contained in an amount of 0.005 part by mass to 10 parts by mass inclusive per 100 parts by weight of a total of the aprotic organic solvent plus carrier salt.

In the aforesaid polymer gel electrolyte, there is vinylene carbonate or its derivative contained.

In the aforesaid polymer gel electrolyte, the solvent contains one or more aprotic organic compounds selected from the group consisting of cyclic polycarbonates, chain carbonates, aliphatic carboxylic acid esters, γ-lactones, cyclic ethers and chain ethers as well as their fluorine derivatives.

In the aforesaid polymer gel electrolyte, the carrier salt contains one or more substances selected from the consisting of LiPF₆, LiBF₄, LiAsF₆, LiSbF₆, LiClO₄, LiAlCl₄, and LiN(CnF₂ₙ₊₁SO₂) (CₙF₂ₙ₊₁SO₂) where n and m are each a natural number.

In the aforesaid polymer gel electrolyte, a polymer that forms the polymer gel is any one of polyacrylate, polyethylene oxide, and polypropylene oxide.

The present invention also provides a polymer secondary battery including the aforesaid polymer gel electrolyte, and further comprising a positive electrode including a lithium-containing composite oxide as a positive electrode active substance and a negative electrode containing as a negative electrode active substance a substance capable of inserting or deinserting lithium.

The polymer gel electrolyte of the invention, because of containing a sulfur-containing organic compound such as a sulfonic acid ester, can hold back the generation of gases due to charge/discharge during initial charging, thereby making sure improved rate and cycle performances.

While why such performances can be improved by the polymer gel of the invention has yet to be clarified, a possible reason could be that a coating film formed on the surface of the negative electrode by a sulfur-containing organic compound such a sulfonic acid ester at the time of initial charging has an effect on smoothing delivery of the negative electrode active substance and electrons, etc.

According to the invention, it has been found that when a secondary battery is fabricated by using a polymer gel containing a sulfonic acid ester or the like in an aprotic solvent, it is possible to obtain a polymer secondary battery that has an improved capacity sustenance rate in the cycle performance and a good enough effect on prevention of cell swelling, and can hold back a resistance increase during storage. Further, by applying the invention to a secondary battery covered around by a flexible film comprising a metal foil and a synthetic resin film, it is possible to hold back resistance increases and prevent the battery from swelling by reason of the generation of gases. Thus, the invention is effectively applied to not only small-size polymer secondary battery of small size for portable equipment but also large-size ones for automobile applications.

Further, the invention is also effectively applied to a lithium polymer battery using as a negative electrode material scaly graphite so far taken to be unsuitable for a negative electrode material, because the generation of gases upon charge/discharge can be held back.

### BRIEF DESCRIPTION OF THE DRAWINGS

The invention will be described with reference to the accompanying drawings, wherein like numbers reference like elements.

FIG. 1 is illustrative of the construction of the positive electrode in the lithium polymer battery of the invention.

FIG. 2 is illustrative of the construction of the negative electrode in the lithium polymer battery of the invention.

FIG. 3 is illustrative of the construction of a battery element of the inventive lithium polymer battery after rolled up.

FIG. 4 is illustrative of a step of applying a covering film around the inventive lithium polymer battery.

### DESCRIPTION OF EXEMPLARY EMBODIMENTS

The polymer gel electrolyte of the invention contains an aprotic organic solvent, a carrier salt, and a sulfur-containing organic compound having at least one —O—SO₂— in its chemical structure.

In the invention, the sulfur-containing organic compound containing at least one —O—SO₂— in its chemical structure is also understood to mean compounds wherein R in —O—SO₂—R is just simply an alkyl or alkylene group, but also it is bonded to O.

Specifically, there is the mention of chain monoesters, chain diesters, cyclic diesters, and intra-molecular cyclic ester such as sultones as well as their derivatives

The polymer gel electrolyte of the invention comprises an aprotic organic solvent, a carrier salt, and a sulfur-containing organic compound having at least one —O—SO₂— in its chemical structure, and a polymer gel.

The polymer gel electrolyte of the invention may be prepared by mixing a polymer such as polyacryl-nitrile, polyethylene oxide, polypropylene oxide, and polyvinylidene fluoride with an aprotic organic solvent, a carrier salt and a sulfur-containing organic compound having at least one —O—SO₂— in its chemical structure.

The polymer gel electrolyte of the invention may also be prepared by mixing a polymerizable monomer having a polymerizable functional group, and an aprotic organic solvent, a carrier salt and a sulfur-containing organic compound having at least one —O—SO₂— in its chemical structure with a polymerization initiator, and cross-linking the mixture by heat, light or the like into a polymer.

It is then particularly preferable that the mixture of the polymerizable monomer with the desired components, as used in the latter case, is polymerized in situ in a battery covering casing.

For the sulfur-containing organic compound having at least one —O—SO₂— in its chemical structure, there is the mention of a chain sulfonic acid ester, a cyclic monosulfonic acid ester, and a cyclic disulfonic acid ester.

For the chain sulfonic acid ester, there is the mention of methyl methanesulfonate, ethyl methane-sulfonate, busulfan (tetramethylene-bis(methanesulfonate), etc.

For the cyclic monosulfonic acid ester, there is the mention of cyclic intramolecular esters such as 1,3-propane sultone, 1,4-butane sultone, α-trifluoromethyl-γ-sultone, β-trifluoromethyl-γ-sultone, γ-trifluoromethyl-γ-sultone, α-methyl-γ-sultone, α,β-di(trifluoromethyl)-γ-sultone, α,α-di (trifluoromethyl)-γ-sultone, α-undeca-fluoropentyl-γ-sultone, α-heptafluoropropyl-γ-sultone, and so on.

Of these compounds, preference is given to methylenemethane disulfonate represented by the following compound 1, ethylenemethane disulfonate represented by compound 2, cyclic compounds represented by compounds 3-9, and 1,3-propane represented by compound 10.

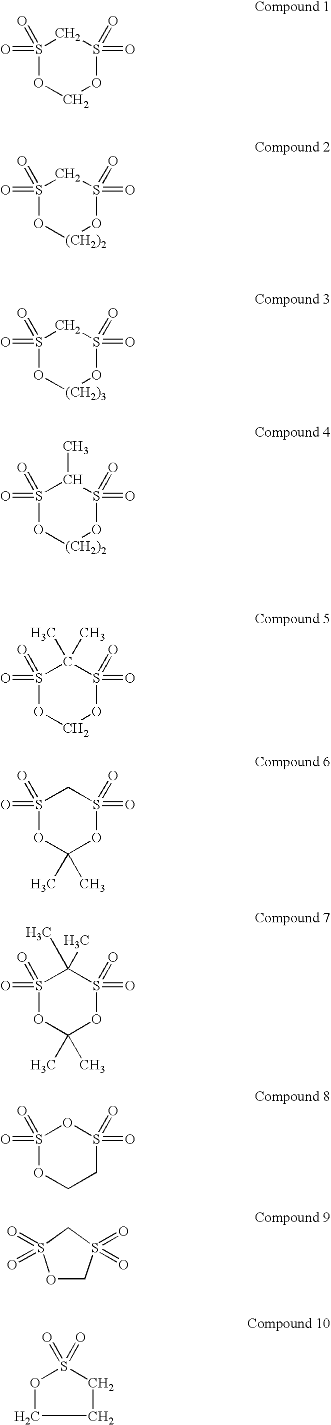

According to the invention, the sulfur-containing organic compound such as cyclic disulfonic acid esters is supposed to form a coating film on the electrode of a lithium secondary battery. That is, with the sulfonic acid ester compounds, the coating film could be formed well prior to the decomposition of an aprotic organic solvent or the like contained in the polymer gel, so that the decomposition of the aprotic organic solvent could be held back, and so could work for prevention of a swell of the battery due to the generation of gases by decomposition, and improvements in rate performance.

Further, when the positive electrode contains a lithium manganese composite oxide such as lithium manganate, that coating film could prevent adsorption of manganese dissolved out in the gel to the surface of the negative electrode, and could consequently work for prevention of a drop of rate performance due to a resistance increase and improvements in cycle performance.

The concentration of the sulfur-containing organic compound in the polymer gel electrolyte of the invention is preferably in the range of 0.005 part by mass to 10 parts by mass inclusive per a total of 100 parts by mass of the aprotic organic solvent plus carrier salt.

That concentration should be more preferably greater than 0.01 part by mass, and even more preferably greater than 0.05 part by mass with the result that battery performance can be improved. At a concentration greater than 10 parts by mass, there is an increase in the resistance of lithium ions to migration. More preferably, the upper limit to this content is 5 parts by mass.

Some sulfur-containing organic compounds may be added in combination of two or more. For instance, the sultone compound that is Compound 10 may be added to Compounds 1 through 9. Alternatively, a vinylene carbonate compound may be added. If this is done, it is then possible to increase the stability of the coating film formed on the surface of the negative electrode, prevent the aprotic organic solvent from breaking down, or holding back degradation of battery performance due to moisture contained in the battery, thereby improving cycle performance, preventing a swell of the cell, and holding back an increase in internal resistance.

The vinylene carbonate and its derivative are added preferably in an amount of 0.1% by mass to 3.0% by mass inclusive per a total of 100 parts by mass of the aprotic organic solvent plus carrier salt.

For the polymerizable monomer that may be used for the preparation of polymer gels, there is the mention of a monomer or oligomer having at least two polymerizable functional groups per molecule. Specifically, the gelation component includes difunctional (meth)acrylates such as ethylene di(meth)acrylate, diethylene glycol di(meth)acrylate) triethylene glycol di(meth) acrylate), tetraethylene glycol di (meth) acrylate), propylene di(meth) acrylate, dipropylene di(meth)acrylate, tripropylene di(meth)acrylate, 1,3-butanediol di(meth)-acrylate, 1,4-butanediol di(meth)acrylate, and 1,6-hexanediol di(meth)acrylate; trifunctional (meth)acrylates such as trimethylolpropane tri(meth)acrylate, and pentaerythritol tri(meth)acrylate; and tetrafunctional (meth)acrylates such as ditrimethylolpropane tetra(meth)-acrylate, and pentaerythritol tetra(meth)acrylate. Besides, there is the mention of monomers such as urethane (meth)acrylates, copolymer oligomers of such monomers, and copolymer oligomers of such monomers with acrylonitriles. Further, use may also be made of polymers that may be dissolved in plasticizers such as polyvinylidene fluoride, polyethylene oxide, and polyacrylonitrile for gelation.

It is here noted that the “(meth)acrylate” means acrylates and/or methacrylates.

The monomers, oligomers or polymers as described above may be used alone or in admixture of two or more, or in admixture with other component capable of gelation.

The aprotic organic solvent used here, for instance, includes cyclic carbonates such as propylene carbonate (PC), ethylene carbonate (EC), butylene carbonate (BC), and vinylene carbonate (VC); chain carbonates such as dimethyl carbonate (DMC), diethyl carbonate (DEC), ethyl methyl carbonate (EMC) and dipropyl carbonate (DPC); aliphatic carboxylic acid esters such as methyl formate, methyl acetate, and ethyl propionate; γ-lactones such as γ-butylolactone; chain ethers such as 1,2-ethoxyethane (DEE), and ethoxymethoxy-ethane (EME); cyclic ethers such as tetrahydrofuran, and 2-methyltetrahydrofuran; dimethysulfoxide; 1,3-dioxolan; formamide; acetamide; dimethylformamide; dioxolan; acetonitrile; propylnitrile; nitromethane; ethyl monoglime; phosphoric acid triester; trimethoxymethane; dioxolan derivatives; sulfolane; methylsulfolane; 1,3-dimethyl-2-imidazolidinone; 3-methyl-2-oxazolidinone; propylene carbonate derivatives; tetrahydrofuran derivatives; ethyl ether; anisole; N-methyl pyrrolidone; and fluorinated carboxylic acid esters, which may be used alone or in admixture of two or more.

The carrier salt used here, for instance, includes LiPF₆, LiAsF₆, LiAlCl₄, LiClO₄, LiBF₄, LiSbF₆, LiCF₃SO₃, LiC₄F₉CO₃, LiC(CF₃SO₂)₃, LiN(CF₃SO₂)₂, LiN(C₂F₅SO₂)₂, LiB₁₀C₁₀, lower aliphatic lithium carboxylate, chloroborane lithium, tetraphenyl lithium borate, LiCl, LiBr, LiI, LiSCN, LiCl, and imides. The concentration of these carrier salts in the polymer gel electrolyte may be 0.5 mol/l to 1.5 mol/l, as calculated on a lithium salt concentration basis. As the concentration is greater than 1.5 mol/l, it causes the characteristics of the polymer electrolyte to become worse, and as the concentration is less than 0.5 mol/l, it causes electroconductivity to become low.

The polymer gel electrolyte of the invention may be obtained by adding a polymerization initiator to a composition comprising a polymerizable substance, an aprotic organic solvent, a carrier salt and a sulfur-containing organic compound having at least one —O—SO₂— in its chemical structure, and polymerizing the polymerizable substance by heating the mixture or irradiating it with light. Preferable polymerization initiators are benzoins and peroxides, although t-butyl peroxypivalate is more preferable.

The polymer gel electrolyte of the invention may be applied to a lithium polymer secondary battery. In this case, its positive electrode is formed by the compression and molding of a collector comprising a metal such as an aluminum foil, which is coated with a positive electrode active substance and then dried, and its negative electrode is formed by the compression and molding of a collector comprising a metal such as a copper foil, which is coated with a negative electrode active substance and then dried. An unwoven fabric, a micro-porous polyolefin film or the like is used for a separator.

The positive and the negative electrode are stacked together with a separator interleaved between them into a stack. Alternatively, the positive and the negative electrode are rolled up with a separator interleaved between them into a roll that is then molded flat. After the stack or roll is encased in a covering casing comprising a metallic can or a flexible covering film, a polymer gel-formation composition prior to polymerization reactions is poured in the casing, and then polymerized in situ, thereby fabricating a lithium polymer battery.

Alternatively, the polymerization may just as well be carried out after the polymer gel-formation composition is poured in the battery casing in advance. Yet alternatively, the positive, the negative electrode and the separator, any one of which is provided with a polymer gel electrolyte coating film, may be assembled into a battery.

For a lithium polymer battery, for instance, one or more selected from the group consisting of a lithium metal, a lithium alloy and a material capable of inserting and deinserting lithium may be used as its negative electrode active substance.

For the material capable of inserting and de-inserting lithium ions, there is the mention of a carbon material, a metal oxide, and metal, all capable of inserting and deinserting lithium.

The carbon material used here includes graphite, amorphous carbon, diamond-like carbon, carbon nano-tubes, and so on, although graphite material and amorphous carbon are particularly preferred. Graphite material is most preferred, because it has high electron conductivity, good adhesion to a collector comprising copper or other metal, good voltage flatness, low impurities content because of being formed at high processing temperatures, and a favorable action on improvements in negative electrode performance.

The metal oxide used here includes any one of silicon oxide, tin oxide, indium oxide, zinc oxide, phosphoric acid and boric acid or their composite materials, although one containing silicon oxide is particularly preferred. Preferably, that metal oxide exists in an amorphous structure form.

This is because silicon oxide is so stable that it does not react with other compound, and because the amorphous structure does not lead to degradation caused by crystal grain boundaries and such heterogeneity as represented by defects. Film-formation techniques include vapor deposition, CVD, sputtering, etc.

For the metal material, lithium and lithium alloys may be mentioned. The lithium alloy may be a binary or ternary alloy comprising lithium and metals such as Al, Si, Sn, In, Ag, Ba, Ca, Pd, Pt, Zn and La. The lithium metal or alloy is most preferably in an amorphous state, because the amorphous structure makes degradations caused by crystal grain boundaries and such heterogeneity as represented by defects less likely.

The lithium metal or alloy may be formed by suitable techniques such as melt cooling, liquid quenching, atomization, vacuum vapor deposition, sputtering, plasma CVD, light CVD, heat CVD, and sol-gel.

The positive electrode active substance, for instance, includes lithium-containing composite oxides such as LiCoO₂, LiNiO₂ and LiMn₂O₄, wherein a transition metal moiety of each lithium-containing composite oxide may be substituted by other element.

A lithium-containing composite oxide having a plateau at greater than 4.5 V that is a metal lithium counter electrode potential. The lithium-containing composite oxide is exemplified by a spinal type lithium manganese composite oxide, an olivine type lithium-containing composite oxide, an anti-spinal type lithium-containing composite oxide or the like. The lithium-containing composite oxide, for instance, may be a compound represented by the following general formula:

Liₐ(MₓMn₂₋ₓ)O₄

where 0<x<2, 0<a<1.2, and M is at least one selected from the group consisting of Ni, Co, Fe, Cr and Cu.

In the invention, the positive electrode may be obtained by dispersing and milling such an active substance together with an electroconductive material such as carbon black and a binder such as polyvinylidene fluoride (PVDF) in a solvent such as N-methyl-2-pyrrolidone (NMP), and coating the product on a substrate such as an aluminum foil.

When the lithium manganese composite oxide is used as the positive electrode active substance, it is preferable that the amount of the sulfur-containing organic compound in the polymer gel electrolyte is 0.1 part by mass to 3.0 parts by mass inclusive, especially 0.5 part by mass to 1.0 part by mass inclusive, per a total of 100 parts by mass of the aprotic organic solvent plus carrier salt. At less than 0.1 part by mass, there is no sufficient coating film formed on the surface of the electrode, less contributing to improvements in cycle performance and rate performance. At greater than 3.0 parts by mass, there is resistance growing high, rendering rate performance worse.

When the lithium cobalt composite oxide is used as the positive electrode active substance, it is preferable that the amount of the sulfur-containing organic compound in the polymer gel electrolyte is 0.5 part by mass to 5.0 parts by mass inclusive per a total of 100 parts by mass of the aprotic organic solvent plus carrier salt. At less than 0.5 part by mass, there is no sufficient coating film formed on the surface of the electrode, less contributing to improvements in cycle performance and rate performance. At greater than 3.0 parts by weight, there is resistance growing high, rendering rate performance worse.

For the separator, a porous film, unwoven fabric or the like of polyolefin such as polyethylene and polypropylene, and a fluororesin may be used. A separator having a stacking structure with different types of porous films or unwoven fabrics stacked one upon another may also be used.

Taking a lithium polymer secondary battery as an example, the polymer battery of the invention is now explained with reference to the accompanying drawings.

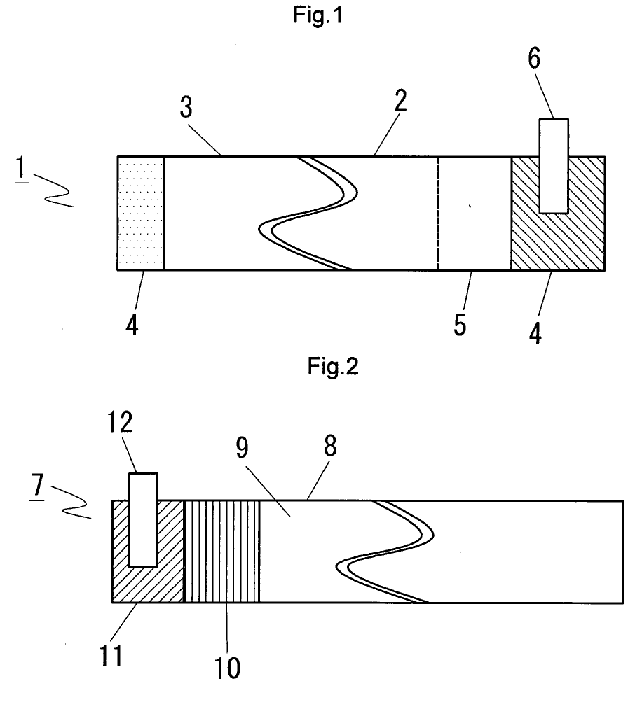

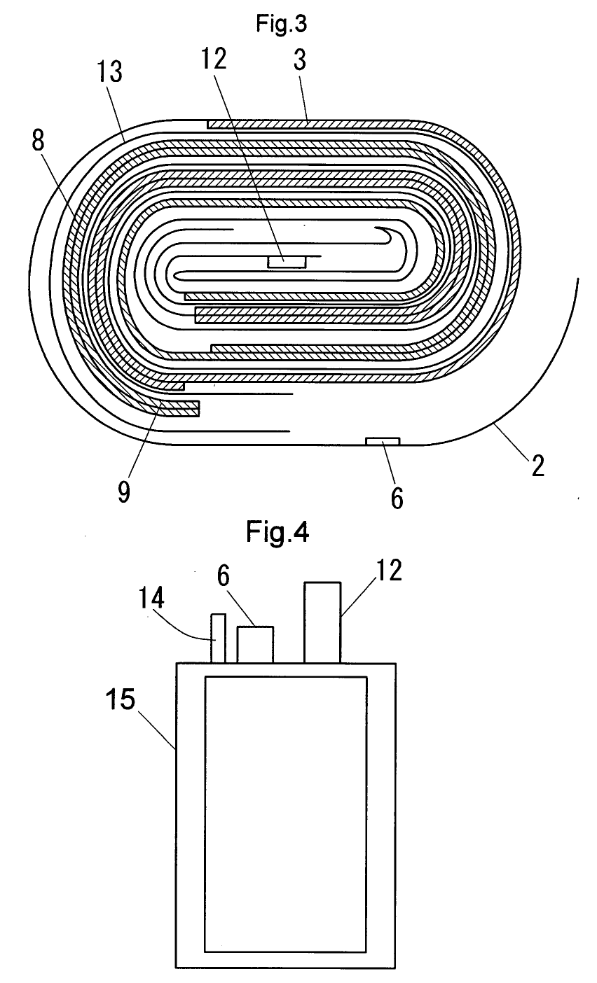

FIG. 1 is illustrative of the construction of the positive electrode in the inventive lithium polymer battery; FIG. 2 is illustrative of the construction of the negative electrode in the inventive lithium polymer battery; FIG. 3 is illustrative in section of the construction of a battery element in the inventive lithium polymer battery in a rolled-up state; and FIG. 4 is illustrative of how to cover the inventive lithium polymer battery.

### EXAMPLE 1-1

### Preparation of Testing Battery

How to prepare the positive electrode is explained with reference to FIG. 1. N-methylpyrrolidone was added to a mixture of 85% by mass of LiMn₂O₄, 7% by mass of acetylene black acting as an electroconductive aid and 8% by mass of polyvinylidene fluoride behaving as a binder, and the resulting mixture was further mixed into a positive electrode slurry. This slurry was coated by means of a doctor blade technique on both surfaces of a 20-μm thick aluminum foil 2 to form a collector at such a thickness as to have a thickness of 160 μm after roll pressing, thereby forming a portion 3 coated with a positive electrode active substance. Both ends of the collector defined portions 4 having no positive electrode active substance on each surface: one of the portions 4 was provided with a positive electrode conduction tab 6, and there was a portion 5 provided adjacent to it, which had a positive electrode active substance coated on its one surface alone. In this way, the positive electrode 1 was assembled.

How to prepare a negative electrode is now explained with reference to FIG. 2. N-methylpyrrolidone was added to a mixture of 90% by mass of scaly graphite and 10% by mass of polyvinylidene fluoride, and the mixture was further mixed into a negative electrode slurry. This slurry was coated on both surfaces of a 10-μm thick copper foil 8 to form a collector at such a thickness as to have a thickness of 120 μm after roll pressing, thereby forming a portion 9 coated with a negative electrode active substance. One of both ends of the collector was provided with a portion 10 having a negative electrode active substance coated on its one surface alone and a portion 11 having no negative electrode active substance coated on it, with the attachment of a negative electrode conduction tab 12 in place. In this way, the negative electrode 7 was assembled.

How to prepare a battery element is explained with reference to FIG. 3. Two separators 13, each formed of a polyethylene microporous film having a thickness of 12 μm and a porosity of 35%, were fused together, cut, and fixed onto the core of a reel. Then, the separator assembly was taken up onto the core with the introduction of the leading ends of the previously prepared positive 1 and negative electrode 7. Note here that the leading end side of the positive electrode 1 was defined by its side facing away from a junction with the positive electrode conduction tab 6 and the leading end side of the negative electrode 7 was defined by its side facing a junction with the negative electrode conduction tab 12. While the negative electrode was inserted between the two separators and the positive electrode was located on the upper surface of the separator assembly, the reel core was turned to prepare the battery element.

This battery element was encased in an embossed covering film, as shown in FIG. 4, the positive and negative electrode conduction tabs 6 and 12 were drawn out, the sides of the covering film were folded back, and thermal fusion was carried out while a pore inlet portion 14 for the polymer gel-formation composition was left intact, thereby preparing a cell 15.

To prepare the polymer gel electrolyte-formation composition, 1 part by mass of 1,3-propane sultone, 3.8 parts by mass of triethylene glycol diacrylate acting as a gelation agent and 1 part by mass of trimethylolpropane triacrylate were fully mixed with 100 parts by mass of an electrolysis solution consisting 30% by mass of ethylene carbonate (EC), 58% by mass of diethyl carbonate (DEC) and 12% by mass of LiPF₆ behaving as a lithium salt. Then, 0.5 part by mass of t-butyl peroxypivalate working as a polymerization initiator was mixed with the resultant mixture.

Then, the cell 14 was placed in a vacuum system, internal gases were evacuated off from within the system, the polymer gel electrolyte-formation composition was poured in the cell through the inlet portion 14, and vacuum impregnation was carried out to obtain Sample 1-1, i.e., lithium polymer secondary battery 15.

1. Rate Performance Testing

After the obtained lithium polymer secondary battery was charged at 20° C. up to a battery voltage of 4.2 V on a constant charge current of 0.2 C, it was charged at a constant voltage until an overall charging time amounted to 6.5 hours. Then, the battery was discharged down to a battery voltage of 3.0 V on a discharge current of 0.2 C. It was the then discharge capacity that was defined as an initial capacity.

The rate performance of the obtained lithium polymer battery is reported in Table 1 in terms of percentage rate performance defined as the ratio between a discharge capacity obtained at 1.0 C discharge rate and a discharge capacity of 100 obtained when the battery charged up to a battery voltage of 4.2 V was discharged down to a battery voltage of 3.0 V on a 0.2 C current.

2. Cycle Test

Cycle testing was done under the conditions that regarding charge, the battery was charged up to the upper limit voltage of 4.2 V on a constant charge current 1 C, and then charged at a constant voltage until an overall charge time amounted to 2.5 hours; and regarding discharge, the battery was discharged down to the lower voltage of 3.0 V on 1 C current, all at 20° C. Percentage capacity sustenance is defined by the ratio between the discharge capacity (1 C) at the first cycle and the discharge capacity (1 C) at the hundredth cycle. The results are reported in Table 1.

The volume (1.0) of the cell after initial charge is also reported in Table 1 in terms of the ratio with respect to the volume of the cell after the cycle testing.

### EXAMPLE 1-2

A test battery or Sample 1-2 was prepared as in Example 1 with the exception that the amount of 1,3-propane sultone added was 0.05 part by mass, and estimation was done as in Example 1-1. The results are reported in Table 1.

### EXAMPLE 1-3

A test battery or Sample 1-3 was prepared as in Example 1 with the exception that the amount of 1,3-propane sultone added was 0.5 part by mass, and estimation was done as in Example 1-1. The results are reported in Table 1.

### EXAMPLE 1-4

A test battery or Sample 1-4 was prepared as in Example 1 with the exception that the amount of 1,3-propane sultone added was 0.1 part by mass, and estimation was done as in Example 1-1. The results are reported in Table 1.

### EXAMPLE 1-5

A test battery or Sample 1-5 was prepared as in Example 1 with the exception that the amount of 1,3-propane sultone added was 2.0 parts by mass, and estimation was done as in Example 1-1. The results are reported in Table 1.

### EXAMPLE 1-6

A test battery or Sample 1-6 was prepared as in Example 1 with the exception that the amount of 1,3-propane sultone added was 3.0 parts by mass, and estimation was done as in Example 1-1. The results are reported in Table 1.

### EXAMPLE 1-7

A test battery or Sample 1-7 was prepared as in Example 1 with the exception that the amount of 1,3-propane sultone added was 4.0 parts by mass, and estimation was done as in Example 1-1. The results are reported in Table 1.

### EXAMPLE 1-8

A test battery or Sample 1-8 was prepared as in Example 1 with the exception that the amount of 1,3-propane sultone added was 5.0 parts by mass, and estimation was done as in Example 1-1. The results are reported in Table 1.

### EXAMPLE 1-9

A test battery or Sample 1-9 was prepared as in Example 1 with the exception that the amount of 1,3-propane sultone added was 10.0 parts by mass, and estimation was done as in Example 1-1. The results are reported in Table 1.

### COMPARATIVE EXAMPLE 1-1

A test battery or Comparative Sample 1-1 was prepared as in Example 1 with the exception that 1,3-propane sultone added was not added, and estimation was done as in Example 1-1. The results are reported in Table 1.

### COMPARATIVE EXAMPLE 1-2

A test battery or Comparative Sample 1-2 was prepared as in Example 1 with the exception that the amount of 1,3-propane sultone added was 12.0 parts by mass, and estimation was done as in Example 1-1. The results are reported in Table 1.

TABLE 1

| | | Rate | Capacity | Volume |
|---|---|---|---|---|
| Sample | 1,3-propane sultone | performance | sustenance | change |
| No. | (part by mass) | (%) | (%) | (%) |
| Ex. 1-1 | 1.0 | 95. | 91 | 1.0 |
| Ex. 1-2 | 0.05 | 65 | 50 | 4.0 |
| Ex. 1-3 | 0.5 | 93 | 89 | 1.0 |
| Ex. 1-4 | 0.1 | 91 | 85 | 1.1 |
| Ex. 1-5 | 2.0 | 83 | 70 | 3.0 |
| Ex. 1-6 | 2.0 | 80 | 64 | 5.0 |
| Ex. 1-7 | 4.0 | 60 | 45 | 5.0 |
| Ex. 1-7 | 5.0 | 54 | 40 | 5.0 |
| Ex. 1-9 | 10.0 | 48 | 33 | 7.0 |
| Comp. Ex. 1-1 | 0 | 40 | 5 | 20 |
| Comp. Ex. 1-2 | 12.0 | 35 | 3 | 25.0 |

### EXAMPLE 1-10

### Preparation of Methylenemethane Disulfonate

Charged into a reaction flask were 213.94 g (0.772 mol) of silver carbonate and 749 ml of acetonitrile, and a solution containing 77.93 g (0.366 mol) of methane-disulfonic acid chloride in 491 ml of acetonitrile was added dropwise into the flask at 40° C. or lower.

After a 24-hour agitation at 25° C., filtration and washing with acetonitrile were carried out to obtain 991.35 g of an acetonitrile solution of methanesulfonic acid silver salt, which contained 126.28 g (0.324 mol) of methanesulfonic acid silver salt. Then, 207.44 g (0.771 mol) of diiodomethane were charged into 991.35 g of this acetonitrile solution of methanesulfonic acid silver salt, and stirring was carried out for 24 hours under reflux. Filtration, washing with acetonitrile and concentration were performed to obtain 89.11 g of yellow pasty residues. Dissolution was done with three additions of 100 ml of methylene chloride. The thus dissolved methylene chloride solution was decolorized and filtrated through active charcoal, and concentrated down to about 5 ml. The precipitated crystals were filtrated, and dried at 50° C. to obtain 4.19 g of white needle-like crystals found to have a melting point of 146 to 147° C. These crystals were found by ¹H-NMR to be methylenemethane disulfonate identified as Compound 1.

Preparation of Test Battery

A test battery or Sample 1-10 was prepared as in Example 1-1 with the exception that 1 part by mass of methylenemethane disulfonate was used in place of 1,3-propane sultone, and estimation was made as in Example 1-1. The results are reported in Table 2.

### EXAMPLE 1-11

A test battery or Sample 1-11 was prepared as in Example 1-1 with the exception that 0.05 part by mass of methylenemethane disulfonate was used in place of 1,3-propane sultone, and estimation was made as in Example 1-1. The results are reported in Table 2.

### EXAMPLE 1-12

A test battery or Sample 1-12 was prepared as in Example 1-1 with the exception that 0.5 part by mass of methylenemethane disulfonate was used in place of 1,3-propane sultone, and estimation was made as in Example 1-1. The results are reported in Table 2.

### EXAMPLE 1-13

A test battery or Sample 1-13 was prepared as in Example 1-1 with the exception that 0.1 part by mass of methylenemethane disulfonate was used in place of 1,3-propane sultone, and estimation was made as in Example 1-1. The results are reported in Table 2.

### EXAMPLE 1-14

A test battery or Sample 1-14 was prepared as in Example 1-1 with the exception that 2.0 parts by mass of methylenemethane disulfonate were used in place of 1,3-propane sultone, and estimation was made as in Example 1-1. The results are reported in Table 2.

### EXAMPLE 1-15

A test battery or Sample 1-15 was prepared as in Example 1-1 with the exception that 3.0 parts by mass of methylenemethane disulfonate were used in place of 1,3-propane sultone, and estimation was made as in Example 1-1. The results are reported in Table 2.

### EXAMPLE 1-16

A test battery or Sample 1-16 was prepared as in Example 1-1 with the exception that 4.0 parts by mass of methylenemethane disulfonate were used in place of 1,3-propane sultone, and estimation was made as in Example 1-1. The results are reported in Table 2.

### EXAMPLE 1-17

A test battery or Sample 1-17 was prepared as in Example 1-1 with the exception that 5.0 parts by mass of methylenemethane disulfonate were used in place of 1,3-propane sultone, and estimation was made as in Example 1-1. The results are reported in Table 2.

### EXAMPLE 1-18

A test battery or Sample 1-18 was prepared as in Example 1-1 with the exception that 10.0 parts by mass of methylenemethane disulfonate were used in place of 1,3-propane sultone, and estimation was made as in Example 1-1. The results are reported in Table 2.

### COMPARATIVE EXAMPLE 1-3

A test battery or Comparative Sample 1-3 was prepared as in Example 1-1 with the exception that 12.0 parts by mass of methylenemethane disulfonate were used in place of 1,3-propane sultone, and estimation was made as in Example 1-1. The results are reported in Table 2.

TABLE 2

| | Methylene | | | |
|---|---|---|---|---|
| | methanedisulfonate | Rate | Capacity | Volume |
| | (part by | performance | sustenance | change |
| Sample No. | mass) | (%) | (%) | (%) |
| Ex. 1-10 | 1.0 | 95 | 94 | 0.7 |
| Ex. 1-11 | 0.05 | 66 | 57 | 7.0 |
| Ex. 1-12 | 0.5 | 93 | 91 | 0.8 |
| Ex. 1-13 | 0.1 | 91 | 88 | 1.0 |
| Ex. 1-14 | 2.0 | 87 | 86 | 1.5 |
| Ex. 1-15 | 3.0 | 80 | 83 | 2.4 |
| Ex. 1-16 | 4.0 | 60 | 51 | 4.0 |
| Ex. 1-17 | 5.0 | 54 | 48 | 4.0 |
| Ex. 1-18 | 10.0 | 48 | 41 | 7.0 |
| Comp. Ex. 1-2 | 0 | 40 | 5 | 20 |
| Comp. Ex. 1-3 | 12.0 | 48 | 13 | 16 |

### EXAMPLE 1-19

A positive electrode was prepared as in Example 1-1 with the exception that N-methylpyrrolidone was further mixed with a mixture consisting of 87% by mass of LiCoO₂ working as a positive electrode active substance, 5% by mass of acetylene black behaving as a electroconductive aid and 8% by mass of polyvinylidene fluoride acting as a binder, and estimation was made as in Example 1-1 with the exception that a polymer secondary battery or Sample 1-19 was prepared by further addition of 0.5 part by mass of vinylene carbonate to the polymer gel electrolyte-formation composition as referred to in Example 1-1. The results are reported in Table 3.

### EXAMPLE 1-20

A test battery or Sample 1-20 was prepared as in Example 1-19 with the exception that the amount of 1,3-propane sultone added was 0.5 part by mass, and estimation was made as in Example 1-1. The results are reported in Table 3.

### EXAMPLE 1-21

A test battery or Sample 1-21 was prepared as in Example 1-19 with the exception that the amount of 1,3-propane sultone added was 2.5 parts by mass, and estimation was done as in Example 1-1. The results are reported in Table 3.

### EXAMPLE 1-22

A test battery or Sample 1-22 was prepared as in Example 1-19 with the exception that the amount of 1,3-propane sultone added was 3.5 parts by mass, and estimation was done as in Example 1-1. The results are reported in Table 3.

### EXAMPLE 1-23

A test battery or Sample 1-23 was prepared as in Example 1-19 with the exception that the amount of 1,3-propane sultone added was 5.0 parts by mass, and estimation was done as in Example 1-1. The results are reported in Table 3.

### EXAMPLE 1-24

A test battery or Sample 1-24 was prepared as in Example 1-19 with the exception that the amount of 1,3-propane sultone added was 10.0 parts by mass, and estimation was done as in Example 1-1. The results are reported in Table 3.

### EXAMPLE 1-25

A test battery or Sample 1-25 was prepared as in Example 1-19 with the exception that the amount of 1,3-propane sultone added was 0.3 part by mass in the absence of vinylene carbonate, and estimation was done as in Example 1-1. The results are reported in Table 3.

### EXAMPLE 1-26

A test battery or Sample 1-26 was prepared as in Example 1-19 with the exception that the amount of 1,3-propane sultone added was 6.0 parts by mass in the absence of vinylene carbonate, and estimation was done as in Example 1-1. The results are reported in Table 3.

### EXAMPLE 1-27

A test battery or Sample 1-27 was prepared as in Example 1-19 with the exception that the amount of 1,3-propane sultone added was 8.0 parts by mass in the absence of vinylene carbonate, and estimation was done as in Example 1-1. The results are reported in Table 3.

### COMPARATIVE EXAMPLE 1-4

A test battery or Comparative Sample 1-1 was prepared as in Example 1-19 with the exception that neither 1,3-propane sultone nor vinylene carbonate was added, and estimation was done as in Example 1-1. The results are reported in Table 3.

### COMPARATIVE EXAMPLE 1-5

A test battery or Comparative Sample 1-5 was prepared as in Example 1-19 with the exception that the amount of 1,3-propane sultone added was 12.0 parts by mass in the absence of vinylene carbonate, and estimation was done as in Example 1-1. The results are reported in Table 3.

TABLE 3

| | 1,3-propane | Rate | Capacity | |
|---|---|---|---|---|
| | sultone (part by | performance | sustenance | Volume |
| Sample No. | mass) | (%) | (%) | change (%) |
| Ex. 1-19 | 1.0 | 95 | 90 | 1.0 |
| Ex. 1-20 | 0.5 | 97 | 91 | 0.8 |
| Ex. 1-21 | 2.5 | 93 | 87 | 1.3 |
| Ex. 1-22 | 3.5 | 91 | 80 | 1.5 |
| Ex. 1-23 | 5.0 | 90 | 76 | 1.7 |
| Ex. 1-24 | 10.0 | 90 | 76 | 1.7 |
| Ex. 1-25 | 0.3 | 87 | 83 | 1.4 |
| Ex. 1-26 | 6.0 | 51 | 51 | 6.0 |
| Ex. 1-27 | 8.0 | 23 | 43 | 7.4 |
| Comp. Ex. 1-4 | 0 | 41 | 7 | 23 |
| Comp. Ex. 1-5 | 12.0 | 10 | 10 | 20 |

### EXAMPLES 1-28 TO 1-33

Test batteries or Samples 1-27 to 1-33 were prepared, provided that the amount of 1,3-propane sultone added was 1 part by mass and the amount of vinylene carbonate added varied between 0.05 and 8.0 parts by mass as shown in Table 4, and estimation was made as in Example 1-1. The results are reported in Table 4.

TABLE 4

| | | Rate | Capacity | |
|---|---|---|---|---|
| Sample | Vinylene carbonate | perfor-mance | sustenance | Volume |
| No. | (part by mass) | (%) | (%) | change (%) |
| Ex. 1-28 | 0.1 | 93 | 90 | 1.3 |
| Ex. 1-29 | 2.0 | 90 | 93 | 1.5 |
| Ex. 1-30 | 3.0 | 80 | 80 | 5.0 |
| Ex. 1-31 | 0.05 | 65 | 50 | 4.0 |
| Ex. 1-32 | 4.0 | 60 | 45 | 5.0 |
| Ex. 1-33 | 8.0 | 54 | 40 | 5.0 |

### EXAMPLE 2-1

The test battery or Sample 1-10 prepared in Example 1-10 was subjected to cycle testing comprising 500 cycles, rather than the estimation method of Example 1-1. That is, cycle testing comprising 500 cycles was carried out as in Example 1-1 to make estimation of percentage capacity sustenance and percentage volume change after 500 cycles. The results are reported in Table 5.

### EXAMPLE 2-2

### Preparation of Ethylenemethane Disulfonate

A 1,2-dimethoxyethane (140 ml) solution of methane-disulfonylchloride (21.33 g; 100 mmol) was added dropwise into a 1,2-dimethoxyethane (DME) (1,000 ml) of anhydrous ethylene glycol (6.21 g; 100 mmol) in a nitrogen stream at −34 to −40° C. under agitation over a period of 20 minutes. Thereafter, a 1,2-dimethoxyethane (140 ml) solution of triethylamine (20.27 g; 200 mmol) was stirred in the reaction solution in a nitrogen stream at −11 to −20° C., and the reaction solution was stirred at 25° C. for a further one hour. After the solvent was distilled off under reduced pressure, the residues were pored in ice-cold water for a 10-minute stirring, after which the precipitated white crystals were filtered out, washed with ice-cold water, and dried at 50° C. under reduced pressure to obtain 10.86 g (53.71 mmol; 53.7%) of ethylenemethane disulfonate identified as Compound 2. This compound was found to have a melting point of 168 to 170° C.

A test battery or Sample 2-2 was prepared as in Example 1-10 with the exception that 1 part by mass of ethylenemethane disulfonate was added in place of methylenemethane disulfonate, and estimation was made as in Example 2-1. The results are reported in Table 5.

### EXAMPLE 2-3

A test battery or Sample 2-3 was prepared as in Example 1-10 with the exception that 1 part by mass of methylenemethane disulfonate plus 1 part by mass of vinylene carbonate was added, and estimation was made as in Example 2-1. The results are reported in Table 5.

### EXAMPLE 2-4

A test battery or Sample 2-4 was prepared as in Example 1-10 with the exception that 1 part by mass of methylenemethane disulfonate plus 1 part by mass of 1,3-propane sultone was added, and estimation was made as in Example 2-1. The results are reported in Table 5.

### EXAMPLE 2-5

A test battery or Sample 2-5 was prepared as in Example 1-10 with the exception that 1 part by mass of methylenemethane disulfonate plus 1 part by mass of vinylene carbonate plus 1 part by mass of 1,3-propane sultone were added, and estimation was made as in Example 2-1. The results are reported in Table 5.

TABLE 5

| | | Capacity | Volume change |
|---|---|---|---|
| | Additive: Amount | sustenance after | after 500 cycles |
| Sample No. | (part by mass) | 500 cycles (%) | (%) |
| Ex. 2-1 | Methylenemethane | 85 | 3.2 |
| | disulfonate 1 | | |
| Ex. 2-2 | Ethylenemethane | 80 | 3.4 |
| | disulfonate 1 | | |
| Ex. 2-3 | Methylenemethane | 91 | 3.4 |
| | disulfonate 1 | | |
| | Vinylene carbonate 1 | | |
| Ex. 2-4 | Methylenemethane | 89 | 3.5 |
| | disulonate 1 | | |
| | 1,3-propane sultone 1 | | |
| Ex. 2-5 | Methylenemethane | 92 | 3.8 |
| | disulfonate 1 | | |
| | Vinylene Carbonate 11 | | |
| | 1,3-Propane sultone 1 | | |

### EXAMPLE 3-1

A test battery or Sample 3-1 was prepared as in Example 1-6 with the exception that as the aprotic organic solvent, 19% by mass of propylene carbonate (PC), 21% by mass of ethylene carbonate (EC) and 48% by mass of diethyl carbonate (DEC) were used in lieu of 30% by mass of ethylene carbonate (EC) and 58% by mass of diethyl carbonate (DEC), and as the negative electrode active substance, amorphous carbon was used for the scaly graphite, and estimation was made as in Example 2-1. The results are reported in Table 6.

### EXAMPLE 3-2

A test battery or Sample 3-2 was prepared as in Example 1-10 with the exception that 1 part by mass of ethylenemethane disulfonate was used in place of methylenemethane disulfonate, and estimation was made as in Example 2-1. The results are reported in Table 6.

TABLE 6

| | | Capacity | Volume change |
|---|---|---|---|
| | Additive: Amount | sustenance after | after 500 |
| Sample No. | (part by mass) | 500 cycles (%) | cycles (%) |
| Ex. 3-1 | Methylenemethane | 86 | 3.2 |
| | disulfonate 1 | | |
| Ex. 3-2 | Ethylenemethane | 81 | 3.4 |
| | disulfonate 1 | | |

### EXAMPLE 4-1

A test battery was prepared as in Sample 3-1 to measure the direct-current resistance value of the secondary battery when stored in a full-charge state.

First, the prepared secondary battery was charged at 20° C. on a constant current until 4.2 V was reached on 0.2 C as in Example 1-1, after which constant voltage charge was carried out until an overall charge time amounted to 6.5 hours. Then, the battery was discharged down to 3.0 V on a 0.2 C constant current. The then discharge capacity was taken as an initial capacity, and the resistance measured then as an initial capacity.

Thereafter, the battery was charged up to a given voltage on a constant current and at a constant voltage for 2.5 hours, and allowed to stand alone at 20° C., 45° C. and 60° C. for 90 days.

At 20° C. after discharge, the battery was discharged down to 3.0 V on 0.2 C, and then charged on a constant 1 C current, after which it was charged at a constant voltage until an overall charge time amounted to 2.5 hours. Thereafter, the battery was discharged down to 3.0 V on 0.2 C, and again charged on a constant 1 C current, after which it was charged at a constant voltage until an overall charge time amounted to 2.5 hours. The resistance of the battery during charge was measured. The results are reported in Table 7.

### EXAMPLE 4-2

A test battery or Sample 4-2 was prepared as in Example 4-1 with the exception that 1 part by mass of ethylenemethane disulfonate was added in place of methylenemethane disulfonate, and estimation was made as in Example 4-1. The results are reported in Table 7.

TABLE 7

| | Percentage | | |
|---|---|---|---|
| | resistance | | Percentage |
| | increase after | Percentage resistance | resistance increase |
| Sample | 90-day storage | increase after 90-day | after 90-day storage |
| No. | (25° C.) | storage (45° C.) | 60° C.) |
| Ex. 4-1 | 1.0 | 1.0 | 1.02 |
| Ex. 4-2 | 1.02 | 1.06 | 1.14 |

The polymer battery using the inventive polymer gel electrolyte has good rate performance, has high percentage capacity sustenance with little or no swelling of the covering film, even after subjected to repeated charge/discharge cycles, and is minimized in terms of an increase in resistivity after storage. The polymer gel electrolyte of the invention may be applied to not only batteries for small-size portable equipment but also large-size batteries for automobiles or the like.

What is claimed is:

1. A polymer gel electrolyte, characterized by comprising an aprotic organic solvent, a carrier salt and a sulfur-containing organic compound having at least one —O—SO₂— in its chemical structure.

2. The polymer gel electrolyte according to claim 1, characterized in that the sulfur-containing organic compound is a chain sulfonic acid ester.

3. The polymer gel electrolyte according to claim 1, characterized in that the sulfur-containing organic compound has a cyclic structure represented by either one of the following chemical formulae 1 and 2 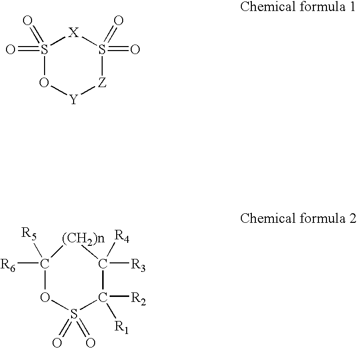
wherein, in chemical formula 1, X is indicative of an alkylene group that may have a side chain, or an oxygen atom; Y stands for an alkylene group that may have a side chain, or an unsubstituted alkylene group; and Z indicates a methylene group or a single bond, and
in chemical formula 2; n is any one of 0, 1, and 2, and R₁-R₆ are each independently selected from a hydrogen atom, an alkyl group having 1 to 12 carbon atoms inclusive, a cycloalkyl group having 3 to 6 carbon atoms inclusive, and an aryl group having 6 to 12 carbon atoms inclusive.

4. The polymer gel electrolyte according to claim 3, the sulfur-containing organic compound having a cyclic structure is at least one of 1,3-propane sultone or 1,4-butane sultone.

5. The polymer gel electrolyte according to claim 3, characterized in that the sulfur-containing organic compound having a cyclic structure is at least one cyclic disulfonic acid ester selected from methylenemethane disulfonate, ethylenemethane disulfonate and propylene-methane disulfonate.

6. The polymer gel electrolyte according to claim 1, characterized in that the sulfur-containing organic compound is contained in an amount of 0.005 part by mass to 10 parts by mass inclusive per 100 parts by weight of a total of the aprotic organic solvent plus carrier salt.

7. The polymer gel electrolyte according to claim 1, characterized by further comprising vinylene carbonate or its derivative.

8. The polymer gel electrolyte according to claim 1, characterized in that the aprotic organic solvent contains at least one selected from the group consisting of cyclic polycarbonates, chain carbonates, aliphatic carboxylic acid esters, γ-lactones, cyclic ethers and chain ethers as well as their fluorine derivatives.

9. The polymer gel electrolyte according to claim 1, characterized in that the carrier salt contains at least one substance selected from the group consisting of LiPF₆, LiBF₄, LiAsF₆, LiSbF₆, LiClO₄, LiAlCl₄, and LiN(CnF₂ₙ₊₁SO₂) (CmF₂ₘ₊₁SO₂) where n and m are each a natural number.

10. The polymer gel electrolyte according to claim 1, characterized in that a polymer that forms a polymer gel is at least one selected from the group consisting of polyacrylate, polyethylene oxide, and polypropylene oxide.

11. A polymer secondary battery, characterized by including a polymer gel electrolyte as recited in claim 1, and further comprising a positive electrode including a lithium-containing composite oxide as a positive electrode active substance and a negative electrode containing as a negative electrode active substance a substance capable of inserting or deinserting lithium.
